(19) United States
(12) Patent Application Publication
(10) Pub. No.: US 2013/0078449 A1
(43) Pub. Date: Mar. 28, 2013

(54) TRANSPARENT ELECTRODE LAMINATE

(71) Applicant: Kabushiki Kaisha Toshiba, Tokyo (JP)

(72) Inventors: Katsuyuki Naito, Tokyo (JP); Eishi Tsutsumi, Kawasaki-shi (JP); Norihiro Yoshinaga, Kawasaki-shi (JP); Yoshihiro Akasaka, Kawasaki-shi (JP)

(73) Assignee: Kabushiki Kaisha Toshiba, Tokyo (JP)

(21) Appl. No.: 13/622,021

(22) Filed: Sep. 18, 2012

(30) Foreign Application Priority Data
Sep. 27, 2011 (JP) 2011-211012

(51) Int. Cl. H01B 1/02; B32B 15/04; B32B 15/02; B82Y 30/00

(52) U.S. Cl. 428/324; 428/332; 428/336; 428/337; 977/762; 977/734

(57) ABSTRACT

According to one embodiment, the transparent electrode laminate includes a transparent substrate and an optically transparent electrode layer formed on the transparent substrate. The electrode layer includes a three-dimensional network of metal nanowires with a diameter of 20 to 200 nm. Each metal nanowire has a reaction inorganic product of a metal constituting the metal nanowire on a part of a surface thereof.

### CROSS-REFERENCE TO RELATED APPLICATIONS

This application is based upon and claims the benefit of priority from Japanese Patent Application No. 2011-211012, filed Sep. 27, 2011, the entire contents of which are incorporated herein by reference.

### FIELD

Embodiments described herein relate generally to a transparent electrode laminate.

### BACKGROUND

A transparent electrode is used for displays such as liquid crystal displays and organic EL displays; and electric devices such as solar batteries. A transparent electrode formed by using metal nanowires such as silver nanowires has been recently suggested. The transparent electrode formed by using metal nanowires has high transparency and low surface resistance. Additionally, the transparent electrode is advantageous in terms of high flexibility. However, since it is formed of metal, the surface scattering of light is large and white turbidity is visually recognized.

Thus, when it is used for a display, an image to be displayed becomes whitish. Further, the flatness of the absorption spectrum is impaired due to the surface plasmon absorption. This causes a problem not only in application of displays but also in application of solar batteries or illumination lamps.

### BRIEF DESCRIPTION OF THE DRAWINGS

FIG. 1 is a schematic view showing a cross-sectional structure of a transparent electrode laminate according to one embodiment;

FIG. 2 is a schematic pattern diagram of an electrode layer of a transparent electrode laminate according to one embodiment;

FIG. 3 is a schematic view showing a cross-sectional structure of a transparent electrode laminate according to another embodiment;

FIG. 4 is a photograph of a transparent electrode laminate of Example 1;

FIG. 5 shows a specular transmission spectrum of the transparent electrode laminate of Example 1;

FIG. 6 is a photograph of a transparent electrode laminate of Comparative Example 1; and

FIG. 7 shows a specular transmission spectrum of the transparent electrode laminate of Comparative Example 1.

### DETAILED DESCRIPTION

In general, according to one embodiment, a transparent electrode laminate includes a transparent substrate and an optically transparent electrode layer formed on the transparent substrate. The electrode layer includes a three-dimensional network of metal nanowires with a diameter of 20 to 200 nm. Each metal nanowire has a reaction inorganic product of the metal constituting the metal nanowire on a part of a surface thereof.

Hereinafter, embodiments will be described with reference to the drawings.

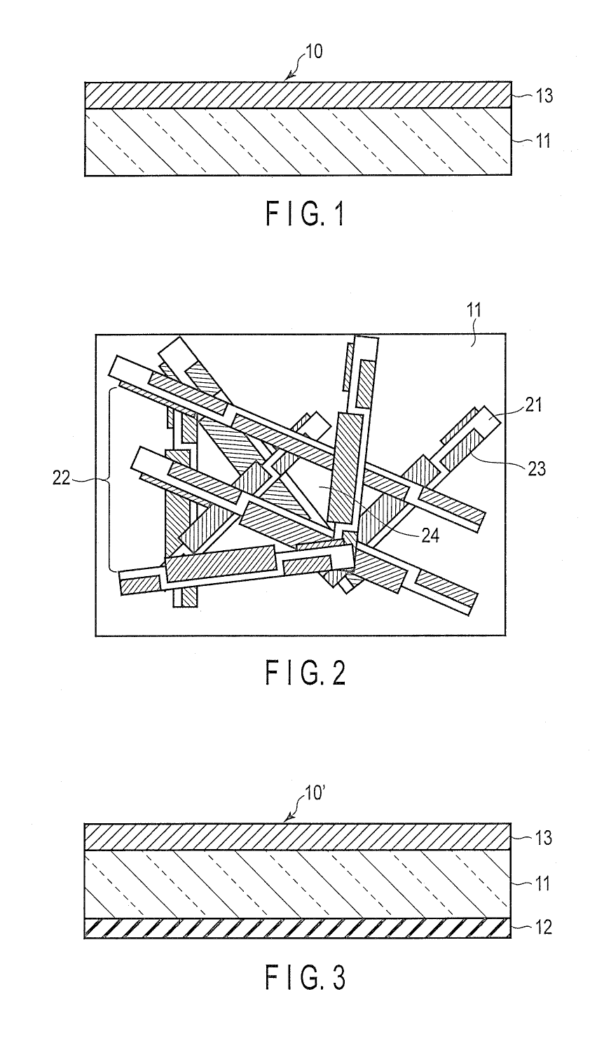

In a transparent electrode laminate 10 shown in FIG. 1, an optically transparent electrode layer 13 is formed on a transparent substrate 11. FIG. 2 shows a pattern diagram in which the electrode layer 13 is seen from the upper surface. The electrode layer 13 on the transparent substrate 11 includes a three-dimensional network 22 of metal nanowires 21 as shown in the pattern diagram of FIG. 2. The metal nanowires fuse partially or completely with each other. The diameter of metal nanowires 21 is from 20 nm to 200 nm. The thickness of the electrode layer 13 can be suitably selected depending on the diameter of the metal nanowires 21. Generally, it is from about 30 to 300 nm.

The material of the metal nanowires 21 can be selected from silver and copper. Silver and copper have an electric resistance as low as 2×10⁻⁸ Ωm or less and are relatively chemically stable, and thus they are preferably used in this embodiment. Gaps 24 in which metal nanowires are not present are present in the three-dimensional network 22 of the metal nanowires 21. The gaps 24 penetrate into the electrode layer 13 in the thickness direction.

In the electrode layer 13, the three-dimensional network 22 is formed by contacting the metal nanowires 21 with one another and is three-dimensionally continued, and thus high conductivity is exhibited. Additionally, light can be transmitted to the gaps 24 in which the metal nanowires 21 are not present. Thus, the conductivity and optical transparency are ensured in the electrode layer 13 of the transparent electrode laminate 10 of this embodiment.

As the whole three-dimensional network 22, the conductivity to be required for electrodes is reliably maintained. As shown in FIG. 2, reaction inorganic products 23 are formed on a part of the surfaces of the metal nanowires 21. The reaction inorganic products 23 are formed on a part of the surfaces of the metal nanowires by reacting a part of the metal on the surfaces of the metal nanowires 21 and the formation method thereof will be described below. The reaction inorganic products 23 are preferably metal sulfides, oxides, halides or a mixture thereof. The halides are not particularly limited and chlorides are preferred because inexpensive hydrochloric acid can be used as a reaction raw material.

The sulfides, oxides or halides of silver or copper have no metallic luster, and most of them are black. The presence of the reaction inorganic products 23 on a part of the surfaces of the metal nanowires 21 allows light scattering to be reduced. Further, the surface plasmon is reduced by the reaction inorganic products 23. Thus, as described later, an effect of reducing the irregularity of the absorption spectrum and improving the flatness is obtained.

As the material of the transparent substrate 11 to support the electrode layer 13, an inorganic material such as glass, an organic material such as polymethylmethacrylate (PMMA), and the like can be used. The thickness of the transparent substrate 11 can be suitably selected depending on the material and the application of the transparent electrode. For example, in the case of a glass substrate, the thickness can be set to about 0.1 to 5 mm. In the case of a PMMA substrate, the thickness can be set to about 0.1 to 10 mm.

As described above, a part of metal on the surfaces of the metal nanowires 21 constituting the three-dimensional network 22 is reacted to form the products 23. The whole three-dimensional network 22 has sufficient conductivity as an electrode. That is, in the metal nanowires in the three-dimensional network 22, the reaction does not progress to a degree which impairs the function as an electrode to produce products.

A transparent substrate formed of an inorganic material has an effect of preventing further chemical reactions of metal nanowires. This is because the substrate shuts off sulfur compound components, halogen compound components, and nitrogen compound components in outside environment. Therefore, in the electrode layer 13 formed on the transparent substrate formed of an inorganic material, the reaction of the metal nanowires 21 is prevented from progressing to the degree which impairs the function as an electrode.

Oxygen and water in outside environment; and amine components, nitrogen compounds, halogen compounds, and sulfur compounds in the air can be transmitted to the transparent substrate 11 formed of an organic material such as PMMA. Further reactions of the metal nanowires 21 in the electrode layer 13 may be progressed by such transmitted components. Formation of a reaction inhibiting layer on the surface of the transparent substrate formed of an organic material allows for the prevention of further reactions of the metal nanowires.

For example, as shown in FIG. 3, a reaction inhibiting layer 12 can be formed on the back of the transparent substrate 11 (the surface at the opposite side of the surface in which the electrode layer 13 is formed). However, when the reaction inhibiting layer is formed below the electrode layer 13, it may be formed on the same surface.

The thickness of the reaction inhibiting layer 12 is not particularly specified as long as it is uniformly formed on a predetermined surface of the transparent substrate formed of an organic material. When the layer has a thickness of about 0.1 to 10 μm, a desired effect is obtained.

Particularly, silicon oxide such as an SiO₂ film is preferred as the material of the reaction inhibiting layer 12 because it has an effect of preventing the diffusion of oxygen and water in outside environment; and amine components, nitrogen compounds, and sulfur compounds in the air. A silicon oxide film can be formed by, for example, a spattering method, a sol gel method or the like. Mica flakes and the like may be mixed into the silicon oxide film. In this case, the effect of preventing diffusion is increased.

Such a reaction inhibiting layer can be formed below the electrode layer 13. In this case, the stability of the electrode layer 13 is further improved.

As described above, the material of the metal nanowires 21 can be selected from silver and copper. As for the transparent electrode laminate formed by using silver nanowires, it is preferable that a specular transmission spectrum satisfies a predetermined condition. The specular transmittance is a transmittance to nearly parallel transmission light without scattered light and it can be measured using a normal ultraviolet-visible absorption spectrometer.

When silver nanowires are used, the specular transmission spectrum has a maximum peak near 320 nm and a minimum peak near 360 nm. An absorbance ratio A₃₆₀/A₃₂₀ may become 2.5 or less. A₃₆₀ represents an absorbance at 360 nm and A₃₂₀ represents an absorbance at 320 nm. Note that the term “near” used herein means a range of ±15 nm. When the absorbance ratio is 2.5 or less, the near-ultraviolet light (wavelength region of 350 to 400 nm) in sunlight can be efficiently used. In addition to this, light from a near-ultraviolet LED or LD near a wavelength of 360 nm can be taken outside with high efficiency.

In the transparent electrode laminate 10 of this embodiment, it is preferable that a carbon layer containing graphene is formed on at least one of the surfaces of the electrode layer 13. In other words, the carbon layer containing graphene may be laminated on at least one of the sides of the three-dimensional network 22 of the metal nanowires 21. The graphene may be a single- or multi-layer. As shown in FIG. 2, the gaps 24 are present in the three-dimensional network 22 of the metal nanowires 21. The gaps 24 contribute to the transparency of the electrode layer 13, but charge exchanges are not performed in the portion. When the carbon layer containing graphene is laminated on the three-dimensional network of metal nanowires, charge exchanges via the carbon layer can be uniformly performed on the whole surface of the electrode layer.

When the carbon layer containing graphene is formed on the three-dimensional network of metal nanowires, the surface flatness can be improved. For example, as for the surface in which a single-layered graphene is formed, the irregularity to be measured with an atomic force microscope (AFM) is about 10 nm or less. In terms of advantages such as charge injection and lamination of an ultra thin film, such a transparent electrode laminate is suitable for, for example, organic EL displays and solar batteries.

In this regard, when the transparent electrode laminate of this embodiment is used as a cathode of the device, it is preferable that a part of the carbon in graphene is substituted with nitrogen. The doping amount (N/C atomic ratio) can be determined based on, for example, an X-ray photoelectron spectroscopy (XPS). The graphene having a doping amount (N/C atomic ratio) of about 1/200 to 1/10 has a work function lower than that of the graphene which is not nitrogen-substituted. Since it is easy to pick up electrons from a functional layer to be connected and to yield electrons to the functional layer, the performance as a cathode is improved.

The electrode layer in the transparent electrode laminate of one embodiment can be formed on a transparent substrate using, for example, a dispersion liquid containing metal nanowires. Specifically, metal nanowires having a diameter of 20 nm to 200 nm are dispersed in a dispersion medium to obtain a dispersion liquid. The diameter of the metal nanowires can be determined with a scanning electron microscope (SEM) or an atomic force microscope (AFM). When the diameter of the metal nanowires is larger than 200 nm, the dispersibility to the dispersion medium is reduced. Thus, it becomes difficult to form a uniform coating film. On the other hand, when the diameter is less than 20 nm, the length of the wires tends to be short, which results in an increase in the surface resistance of a coating film. The diameter of the metal nanowires is more preferably from 60 nm to 150 nm.

The average length of the metal nanowires can be appropriately determined taking into consideration the conductivity and transparency of an electrode to be obtained. Specifically, the average length is preferably 1 μm or more from the viewpoint of conductivity. In order to avoid a decrease in the transparency due to aggregation, the average length is preferably 100 μm or less. An optimal length is determined depending on the diameter of the metal nanowires, and a ratio of the length and diameter (length/diameter) of the metal nanowires can be set to, for example, about 100 to 1000.

Silver nanowires having a predetermined diameter can be obtained from, for example, Seashell Technology. Alternatively, the silver nanowires having a predetermined diameter may be produced based on the literature review “Liangbing Hu et al., ACS Nano, Vol. 4, No. 5, p. 2955 (2010)”. Copper nanowires having a predetermined diameter may be produced based on, for example, JP-A 2004-263318 (KOKAI) or JP-A 2002-266007 (KOKAI). However, the nanowires are not limited to these nanowires as long as the metal nanowires to be used in the embodiment are obtained.

The dispersion medium for dispersing metal nanowires is not particularly limited as long as it does not oxidize metal and can be easily removed by drying. For example, methanol, ethanol, isopropanol, and the like can be used. The concentration of metal nanowires in the dispersion liquid is not particularly specified, and it may be appropriately set within a range which ensures a good dispersion state.

The dispersion liquid containing metal nanowires is applied to the surface of the transparent substrate by, for example, spin-coating, bar-coat printing, ink-jet printing or the like to form a coating film. The dispersion medium is removed by drying, for example, in a nitrogen or argon flow at about 50 to 100° C. for about 0.5 to 2 hours and a three-dimensional network of metal nanowires is obtained. In any case, a three-dimensional network having a desired thickness can be formed by repeatedly performing a process of applying and drying the dispersion liquid.

When the transparent substrate is a glass substrate, it is desirable to perform a hydrophilization treatment on the surface on which the coating film is formed. The hydrophilization treatment can be performed by, for example, a nitrogen plasma treatment. Specifically, the nitrogen plasma treatment can be performed by leaving the substrate in a nitrogen plasma (0.1 millibar) for about 10 minutes using a magnetron sputtering apparatus (13.56 MHz, 150 W). When the surface hydrophilicity of the glass substrate on which the coating film is formed is improved, the uniformity of the coating film becomes better.

When the transparent substrate is formed of an organic material such as PMMA, the reaction inhibiting layer is formed on at least one of the surfaces. It is not necessary to form the reaction inhibiting layer on the PMMA substrate before coating with the dispersion liquid containing metal nanowires. When the reaction inhibiting layer is formed on the surface opposite to the electrode layer, the reaction inhibiting layer may be formed after the reaction of metal nanowires.

The transparent electrode laminate of this embodiment is obtained by reacting a part of the surfaces of metal nanowires disposed on the transparent substrate to form reaction inorganic products. The reaction in the process may be sulfuration, oxidation, or halogenation. For example, a predetermined reactive gas may be reacted with the three-dimensional network of metal nanowires in a gaseous phase. Sulfur vapor and hydrogen sulfide gas are preferred to obtain sulfides. Ozone gas is preferred to obtain oxides. The reaction rate is increased by reacting with ozone gas while irradiating with UV light. Halogen gas alone or hydrogen halide gas may be used to obtain halides. Particularly, chlorine gas is preferred.

The above-described method includes a process of forming a three-dimensional network of metal nanowires on a transparent substrate and reacting a part of surfaces of the metal nanowires (reaction after coating). Thus, the surface resistance and transmittance of the electrode layer to be formed can be controlled for every substrate, and thus it is possible to be applicable to various required specifications.

When products are formed by reacting a part of the metal surfaces, the luster of metal nanowires is reduced. However, the surface resistance of the electrode layer is increased. In this embodiment, the surface resistance of the electrode layer is desirably 100 Ω/□ or less. Therefore, the surfaces of the metal nanowires are reacted while controlling so that the surface resistance is not excessively increased. The conditions to obtain an appropriate surface resistance can be previously examined by, for example, performing a preliminary experiment. Alternatively, the reaction may be controlled by a procedure of measuring a transmission spectrum.

A part of the surfaces of metal nanowires may be reacted before disposition on the transparent substrate. In this case, a dispersion liquid containing metal nanowires is first prepared and a part of the surfaces of metal nanowires is reacted in the dispersion liquid (reaction before coating). For example, a part of the surfaces of metal nanowires can be reacted by introducing reactive gas while stirring the dispersion liquid containing metal nanowires. Alternatively, a solution obtained by previously dissolving reactive gas and an active substance may be added to the dispersion liquid containing metal nanowires while stirring them. The active substance means sulfur, hydrosulfuric acid, hydrochloric acid, potassium permanganate or the like. The method for using reactive gas is suitable for mass production. When the solution is used, the reaction can be controlled with more sufficient accuracy.

The reactive gas and active substance in the reaction before coating can be suitably selected depending on target reaction inorganic products. Particularly, hydrogen sulfide gas or hydrogen sulfide water is preferred to obtain sulfides. Ozone gas or a potassium permanganate aqueous solution is preferred to obtain oxides. Halogen gas alone and halide acid are preferred to obtain halides. Particularly, chlorine gas or hydrochloric acid is preferred.

The transparent substrate is coated with the dispersion liquid containing metal nanowires in which reaction inorganic products are formed on a part of the surfaces to form a coating film. The dispersion medium is removed by drying, for example, in a nitrogen or argon flow at about 50 to 100° C. for about 0.5 to 2 hours and a three-dimensional network of metal nanowires in which reaction inorganic products are generated on a part of the surfaces is obtained. The three-dimensional network of metal nanowires becomes an electrode layer.

As already explained, when the transparent substrate is a glass substrate, it is desirable to perform a hydrophilization treatment on the surface on which the coating film is formed. When the transparent substrate is formed of PMMA, the above-described reaction inhibiting layer is formed on at least one of the surfaces.

In the method including reacting a part of the surfaces of metal nanowires in the dispersion liquid, the resistance at the point of contact of metal nanowires tends to be increased. When the surface resistance of a transparent electrode laminate to be obtained is compared with that of a transparent electrode laminate obtained by the above-described method, the surface resistance is increased. However, a function as an electrode is not impaired. Since the dispersion liquid containing metal nanowires in which a part of the surfaces is pre-reacted is used, the performance variation between the substrates can be reduced. Accordingly, it can be said that it is a method suitable for mass production.

As with the case of the reaction before coating, when the electrode layer is formed by the reaction after coating, the luster of metal nanowires is reduced by the formation of reaction inorganic products on a part of the metal surfaces. However, the surface resistance of the electrode layer is increased. In this embodiment, the surface resistance of the electrode layer is desirably 200 Ω/□ or less. Therefore, the surface of the metal nanowires is reacted while controlling so that the surface resistance is not excessively increased. The conditions to obtain an appropriate surface resistance can be previously examined by, for example, performing a preliminary experiment. Alternatively, the reaction may be controlled by a procedure of measuring a transmission spectrum.

As described above, the reaction of the surfaces of metal nanowires is performed while controlling so that the surface resistance does not become excessively large. Therefore, despite the fact that the light scattering of the transparent electrode laminate of this embodiment is reduced, the transparency and conductivity are equivalent to those of conventional transparent electrodes.

Hereinafter, specific examples of the transparent electrode lamination layer will be shown.

### Example 1

A 0.4 mm-thick glass substrate is used as the transparent substrate 11 to produce a transparent electrode laminate having the structure shown in FIG. 1. As a raw material of the electrode layer 13, a methanol dispersion liquid containing silver nanowires with an average diameter of 115 nm is used. The concentration of the silver nanowires in the dispersion liquid is about 0.3% by mass. Silver nanowires with an average diameter of 115 nm, manufactured by Seashell Technology, are used.

The surface hydrophilicity of the glass substrate is improved by performing a nitrogen plasma treatment. Specifically, the nitrogen plasma treatment is performed by leaving the substrate in a nitrogen plasma (0.1 millibar) for 10 minutes using a magnetron sputtering apparatus (13.56 MHz, 150 W). The dispersion liquid containing silver nanowires is dropwise applied onto the treated glass substrate and they are naturally diffused to form a coating film.

Methanol as a dispersion medium is removed from the coating film by drying in an argon flow at 60° C. for 1 hour, and a three-dimensional network of silver nanowires is obtained. The glass substrate in which the three-dimensional network of silver nanowires is formed is put in a glass container. The silver nanowires are reacted with sulfur vapor in the air at 80° C. for 18 minutes. The sulfur vapor is produced by heating sulfur powder. A part of the silver nanowire surface is sulfurized and a transparent electrode laminate of this example is obtained. The thickness of the electrode layer in the transparent electrode laminate is about 200 nm.

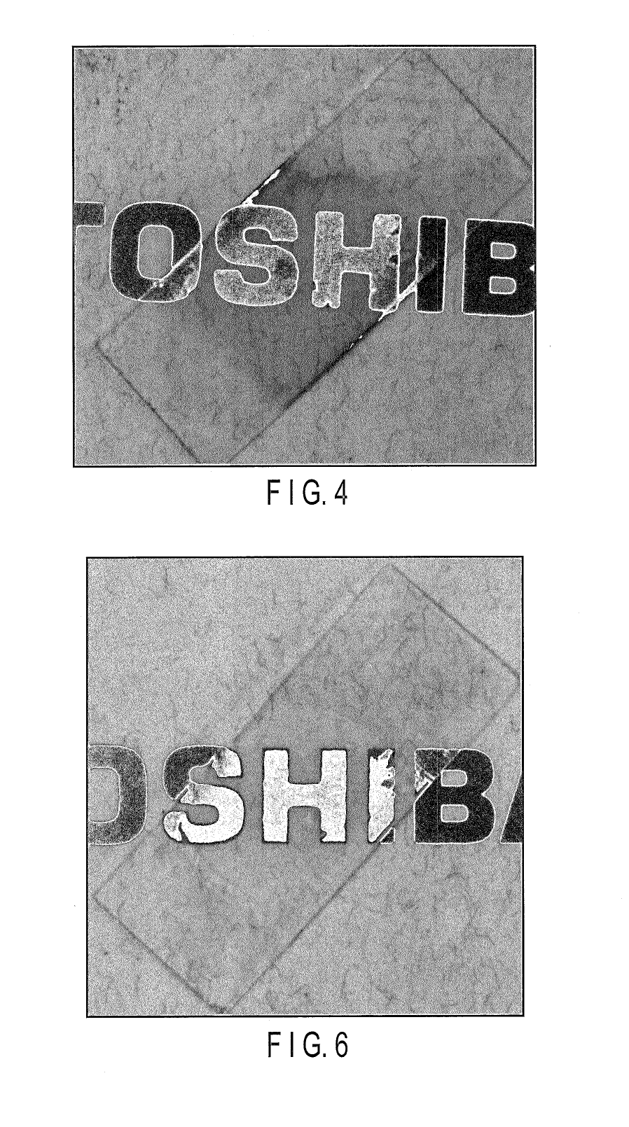

FIG. 4 shows a photograph of the obtained transparent electrode laminate. Since no white turbidity is recognized, it is found that light scattering is little. The specular transmission is measured using a visible-ultraviolet recording spectrophotometer and the surface resistance is determined by a four probe method. The specular transmission is 73% (550 nm) and the surface resistance is 10 Ω/□.

Since people's visibility is high, the specular transmission at 550 nm is evaluated. The required value of the surface resistance varies depending on the device to be used. Generally, in the case of a touch panel, the surface resistance is several 100 Ω/□ or less. In the case of a liquid crystal display, the surface resistance is several 10 Ω/□ or less. In the case of an organic EL device or solar battery, the surface resistance is 10 Ω/□ or less.

FIG. 5 shows a specular transmission spectrum of the transparent electrode laminate of this example. A maximum peak of transmittance is present near 320 nm and a minimum peak of transmittance is present near 360 nm. The absorbance ratio (A₃₆₀/A₃₂₀: A₃₆₀ is an absorbance at 360 nm and A₃₂₀ is an absorbance at 320 nm) thereof is as low as 1.9. Since the irregularity of the absorption spectrum is relatively small, the transparent electrode laminate of this example can be suitably used for a device using near ultraviolet rays near 360 nm.

### Comparative Example 1

A transparent electrode laminate of this comparative example is produced in the same manner as described in Example 1 except that a treatment with sulfur vapor is not performed. FIG. 6 shows a photograph of the transparent electrode laminate of this comparative example. White turbidity is confirmed and it is found that the amount of light scattering is large. The obtained transparent electrode laminate has a specular transmittance of 73% (550 nm) and a surface resistance of 6 Ω/□.

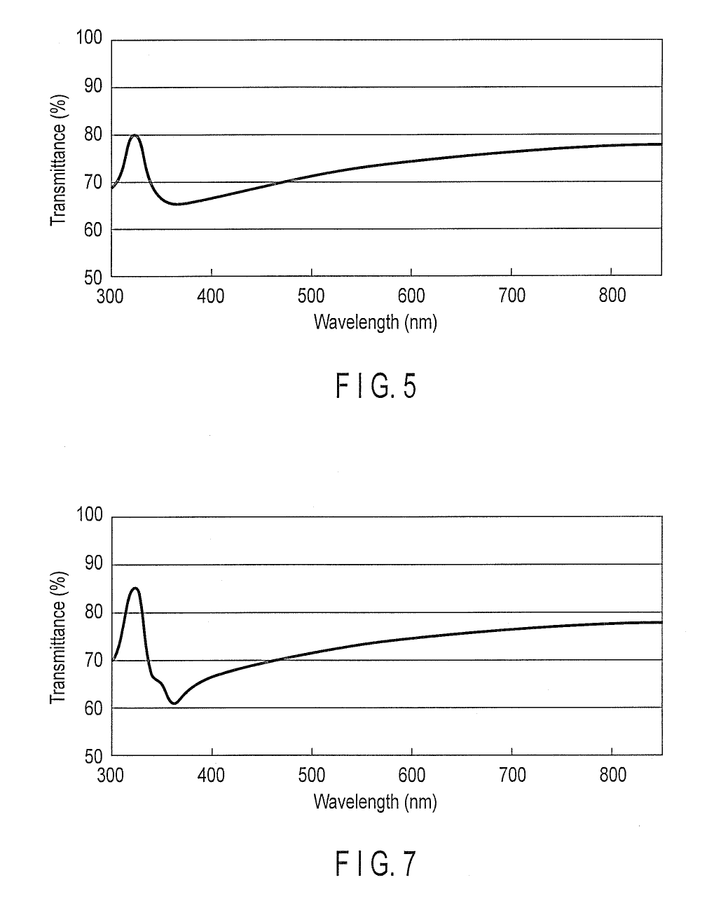

FIG. 7 shows a specular transmission spectrum of the transparent electrode laminate of this comparative example. A transmittance maximum peak is present near 320 nm and a transmittance minimum peak is present near 360 nm. The absorbance ratio (A₃₆₀/A₃₂₀: A₃₆₀ is an absorbance at 360 nm and A₃₂₀ is an absorbance at 320 nm) thereof is 3.0, which is larger than that in Example 1. Such a transparent electrode laminate is not suitable for the device using near ultraviolet rays near 360 nm.

### Example 2

A polymethylmethacrylate (PMMA) substrate is used as the transparent substrate 11 to produce a transparent electrode laminate having the structure shown in FIG. 3. As a raw material of the electrode layer 13, a methanol dispersion liquid containing silver nanowires with an average diameter of 60 nm is used. The concentration of the silver nanowires in the dispersion liquid is about 0.3% by mass. The silver nanowires used herein are manufactured by Seashell Technology.

As a substrate for transcription, a glass substrate subjected to a hydrophilic treatment in the same manner as described in Example 1 is first prepared. A three-dimensional network of silver nanowires is formed on the glass substrate in the same procedure as described in Example 1. The glass substrate in which the three-dimensional network of silver nanowires is formed is put in a glass reaction vessel. The silver nanowires are reacted with sulfur vapor in the air at 80° C. for 6 minutes. A part of the silver nanowire surface is sulfurized and an electrode layer in the transparent electrode laminate of this example is formed. The thickness of the electrode layer in the transparent electrode laminate is about 110 nm.

A solution of a substrate material is obtained by dissolving PMMA in ethyl acetate to prepare 5% by mass of a solution. The electrode layer is coated with the solution, followed by drying under reduced pressure. Specifically, ethyl acetate is removed by drying with an oil rotary vacuum pump equipped with a trap cooled with dry ice and a PMMA film is formed on the electrode layer. The electrode layer is transferred onto the PMMA film by peeling the PMMA film together with the electrode layer including a three-dimensional network of silver nanowires sulfur-treated from the glass substrate in water. An SiO₂ film is formed on the other side surface of the PMMA film by sputtering to form a reaction inhibiting layer, and the transparent electrode laminate of this example is obtained.

In the transparent electrode laminate of this example, no white turbidity is visually recognized, similarly to the case of Example 1, and thus light scattering is little. In a specular transmission spectrum having a specular transmission of 92% (550 nm) and a surface resistance of 80 Ω/□, an absorbance ratio of a transmittance maximum peak near 320 nm and a transmittance minimum peak near 360 nm is 2.4. The absorbance ratio is A₃₆₀/A₃₂₀, where A₃₆₀ is an absorbance at 360 nm and A₃₂₀ is an absorbance at 320 nm. When the absorbance ratio has such a level, the laminate can be suitably used for the device using near ultraviolet rays near 360 nm.

### Comparative Example 2

A transparent electrode laminate of this comparative example is produced in the same manner as described in Example 2 except that a treatment with sulfur vapor is not performed. The obtained transparent electrode laminate has a specular transmission of 92% (550 nm) and a surface resistance of 30 Ω/□. However, white turbidity equal to that of Comparative Example 1 is confirmed. Therefore, the light scattering of the transparent electrode laminate of this comparative example is not suppressed.

In the specular transmission spectrum, the absorbance ratio of a transmittance maximum peak near 320 nm and a transmittance minimum peak near 360 nm is 4.5. The absorbance ratio is A₃₆₀/A₃₂₀, where A₃₆₀ is an absorbance at 360 nm and A₃₂₀ is an absorbance at 320 nm. Since the absorbance ratio is larger than that of Comparative Example 1, the transparent electrode laminate of this comparative example is not suitable for the device using near ultraviolet rays near 360 nm.

### Example 3

A 0.5 mm-thick glass substrate is used as the transparent substrate 11 to produce a transparent electrode laminate having the structure shown in FIG. 1. As a raw material of the electrode layer 13, a methanol dispersion liquid containing copper nanowires with an average diameter of 90 nm is used. The concentration of the copper nanowires in the dispersion liquid is about 0.2% by mass. The copper nanowire is produced based on JP-A 2004-263318 (KOKAI).

The hydrophilicity of the surface of the glass substrate is improved in the same procedure as described in Example 1. The dispersion liquid containing copper nanowires is dropwise applied onto the glass substrate and they are naturally diffused to form a coating film.

Methanol is removed from the coating film by drying in an argon flow at 60° C. for 1 hour, and a three-dimensional network of copper nanowires is obtained. A part of the copper nanowire surface is sulfurized in the same procedure as described in Example 1 and a transparent electrode laminate of this example is obtained. The thickness of the electrode layer in the transparent electrode laminate is about 170 nm.

The transparent electrode laminate of this example has a specular transmission of 60% (550 nm) and a surface resistance of 30 Ω/□. When visually observed, no white turbidity is recognized, similarly to the case of Example 1, and thus the transparent electrode laminate of this example has little light scattering.

### Comparative Example 3

A transparent electrode laminate of this comparative example is produced in the same manner as described in Example 3 except that a treatment with sulfur vapor is not performed. The transparent electrode laminate of this comparative example has a specular transmission of 60% (550 nm) and a surface resistance of 30 Ω/□. However, white turbidity equal to that of Comparative Example 1 is caused and the amount of light scattering is large.

### Example 4

A three-dimensional network of silver nanowires is formed on a glass substrate in the same manner as described in Example 1. The glass substrate in which the three-dimensional network of silver nanowires is formed is put in an UV-ozone cleaner. The silver nanowires are reacted with ozone vapor for 10 minutes while irradiating with UV light. A source of UV light to be used herein is a low-pressure mercury lamp. The ozone vapor is generated by a reaction of oxygen in the air. A part of the silver nanowire surface is oxidized and a transparent electrode laminate of this example is obtained. The thickness of the electrode layer in the transparent electrode laminate is about 200 nm.

The transparent electrode laminate of this example has a specular transmission of 75% (550 nm) and a surface resistance of 20 Ω/□. When visually observed, no white turbidity is recognized, similarly to the case of Example 1, and thus the transparent electrode laminate of this example has little light scattering.

### Example 5

A three-dimensional network of silver nanowires is formed on a glass substrate in the same manner as described in Example 1. The glass substrate in which the three-dimensional network of silver nanowires is formed is put in a glass reaction vessel. The silver nanowires are reacted with a mixed gas of chlorine and nitrogen at room temperature for 10 minutes. A part of the silver nanowire surface is salified and a transparent electrode laminate of this example is obtained. The thickness of the electrode layer in the transparent electrode laminate is about 200 nm.

The transparent electrode laminate of this example has a specular transmission of 80% (550 nm) and a surface resistance of 30 Ω/□. When visually observed, no white turbidity is recognized, similarly to the case of Example 1, and thus the transparent electrode laminate of this example has little light scattering.

### Example 6

Cu foil is used as an underlayer catalyst layer and a single-layered graphene substituted by nitrogen is produced by a CVD method. The CVD method is performed at 1000° C. for 5 minutes using a mixed gas of ammonia, methane, hydrogen, and argon (15:60:65:200 ccm) as a reaction gas. Most of the graphene to be obtained is a single-layered graphene, and a two- or multi-layered graphene is partially produced depending on the conditions.

Further, the graphene is treated in a mixed flow of ammonia and argon (15:200 ccm) at 1000° C. for 5 minutes, followed by cooling in an argon flow. The Cu foil surface is previously annealed by performing a heat-treatment by laser radiation to increase the crystal grain size. As a result, the size of the graphene domain to be obtained becomes larger, and the conductivity is improved. A PET film having a thickness of 150 μm in which the surface as a thermal transfer film is coated with silicone resin is pressure-bonded to the single-layered graphene. Then, Cu constituting the underlayer catalyst layer is dissolved to transfer the single-layered graphene onto a transfer film. In order to dissolve Cu, it is immersed in an ammonia alkaline copper chloride etchant. The same operation is repeated, thereby laminating the four-layered graphene onto the transfer film.

The doping amount (N/C atomic ratio) of nitrogen in graphene can be estimated by the X-ray photoelectron spectroscopy (XPS). In the graphene obtained in the process, the doping amount of nitrogen is from 1 to 2 atm %.

A three-dimensional network of silver nanowires is formed on the four-layered film of graphene in the same procedure as described in Example 1. The transfer film having graphene in which the three-dimensional network of silver nanowires is formed is put in a glass reaction vessel. A part of the silver nanowire surface is sulfurized in the same procedure as described in Example 1 and the electrode layer in the transparent electrode laminate of this example is formed. The electrode layer in this example includes a three-dimensional network of silver nanowires sulfur-treated and graphene.

A solution of a substrate material is obtained by dissolving PMMA in ethyl acetate to prepare 5% by mass of a solution. The electrode layer is coated with the solution, followed by drying under reduced pressure. Specifically, ethyl acetate is removed by drying with an oil rotary vacuum pump equipped with a trap cooled with dry ice and a PMMA film is formed on the electrode layer. The electrode layer including a three-dimensional network of silver nanowires sulfur-treated and graphene is transferred onto the PMMA film by peeling the PMMA film from the transfer film. An SiO₂ film is formed on the other side surface of the PMMA film by sputtering to form a reaction inhibiting layer, and the transparent electrode laminate of this example is obtained.

The transparent electrode laminate of this example has a specular transmission of 60% (550 nm) and a surface resistance of 10 Ω/□. When visually observed, no white turbidity is recognized, similarly to the case of Example 1, and thus the transparent electrode laminate of this example has little light scattering. When observed with an atomic force microscope (AFM), the surface irregularity is 10 nm or less and thus the surface is flat.

### Example 7

The same methanol dispersion liquid containing silver nanowires as that of Example 1 is prepared and a part of the silver nanowire surface is sulfurized in the following procedure. First, dilute sulfuric acid is reacted with iron sulfide. The generated hydrogen sulfide gas is dissolved in pure water to obtain hydrogen sulfide water. The hydrogen sulfide water is added to the methanol dispersion liquid containing silver nanowires with a measuring cylinder. The temperature of the dispersion liquid is increased to 40° C. with an oil bath to react the dispersion liquid. After 5 minutes, a part of the silver nanowire surface is sulfurized and reaction inorganic products (silver sulfide) are produced.

A glass substrate whose surface hydrophilicity is improved in the same procedure as described in Example 1 is prepared. The dispersion liquid containing silver nanowires in which silver sulfide is produced on a part of the silver nanowire surface is dropwise applied onto the glass substrate to form a coating film. Methanol is removed from the coating film by drying in an argon flow at 60° C. for 1 hour, and a three-dimensional network of silver nanowires sulfur-treated is obtained. The three-dimensional network becomes the electrode layer in the transparent electrode laminate of this example. In this manner, the transparent electrode laminate of this example is produced.

The transparent electrode laminate of this example has a specular transmission of 80% (550 nm) and a surface resistance of 100 Ω/□. When visually observed, no white turbidity is recognized, similarly to the case of Example 1, and thus the transparent electrode laminate of this example has little light scattering.

### Example 8

The same methanol dispersion liquid containing copper nanowires as that of Example 3 is prepared and a part of the copper nanowire surface is sulfurized in the following procedure. First, dilute sulfuric acid is reacted with iron sulfide. The generated hydrogen sulfide gas is dissolved in pure water to obtain hydrogen sulfide water. The hydrogen sulfide water is added to the methanol dispersion liquid containing copper nanowires with a measuring cylinder. The temperature of the dispersion liquid is increased to 40° C. with an oil bath to react the dispersion liquid. After 3 minutes, a part of the copper nanowire surface is sulfurized and reaction inorganic products (copper sulfide) are produced.

A glass substrate whose surface hydrophilicity is improved in the same procedure as described in Example 3 is prepared. The dispersion liquid containing copper nanowires in which copper sulfide is produced on a part of the copper nanowire surface is dropwise applied onto the glass substrate to form a coating film. Methanol is removed from the coating film by drying in an argon flow at 60° C. for 1 hour, and a three-dimensional network of copper nanowires sulfur-treated is obtained. The three-dimensional network becomes the electrode layer in the transparent electrode laminate of this example. In this manner, the transparent electrode laminate of this example is produced.

The transparent electrode laminate of this example has a specular transmission of 65% (550 nm) and a surface resistance of 200 Ω/□. When visually observed, no white turbidity is recognized, similarly to the case of Example 1, and thus the transparent electrode laminate of this example has little light scattering.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transparent electrode laminate comprising:
a transparent substrate; and
an optically transparent electrode layer formed on the transparent substrate, the electrode layer comprising a three-dimensional network of metal nanowires with a diameter of 20 to 200 nm, each metal nanowire comprising a reaction inorganic product of a metal constituting the metal nanowire on a part of a surface thereof.

2. The laminate according to claim 1, wherein the metal nanowires are made from silver or copper, and the reaction inorganic products are selected from sulfides, oxides, and halides.

3. The laminate according to claim 2, wherein the metal nanowires are made from silver, and have a relationship of A₃₆₀/A₃₂₀<2.5, where A₃₆₀ is an absorbance at a minimum transmission peak near 360 nm and A₃₂₀ is an absorbance at maximum transmission peak 320 nm, in a specular transmission spectrum.

4. The laminate according to claim 1, wherein the metal nanowires have a diameter of 60 to 150 nm.

5. The laminate according to claim 1, wherein the metal nanowires has an average length of 1 to 100 μm.

6. The laminate according to claim 1, wherein the metal nanowires a ratio of a length and diameter (length/diameter) of 100 to 1000.

7. The laminate according to claim 1, wherein the electrode layer has a thickness of 30 to 300 nm.

8. The laminate according to claim 1, further comprising a carbon layer which comprises a single and/or multi-layered graphene and formed on at least one surface of the three-dimensional network of metal nanowires.

9. The laminate according to claim 8, wherein the carbon layer is formed on the three-dimensional network of the metal nanowires.

10. The laminate according to claim 8, wherein a part of carbon atoms in the graphene is substituted by a nitrogen atom.

11. The laminate according to claim 10, wherein in the grapheme, an atom ratio of nitrogen to carbon (N/C) is from 1/200 to 1/10.

12. The laminate according to claim 1, wherein the transparent substrate is made from organic material and further comprises a reaction inhibiting layer to inhibit a reaction of the metal nanowires on at least one surface thereof.

13. The laminate according to claim 12, wherein the reaction inhibiting layer has a thickness of 0.1 to 10 μm.

14. The laminate according to claim 12, wherein the reaction inhibiting layer is a silicon oxide film.

15. The laminate according to claim 14, wherein the silicon oxide film is formed by a spattering method or a sol gel method.

16. The laminate according to claim 14, wherein mica flakes are mixed in the silicon oxide film.

17. The laminate according to claim 1, wherein the transparent substrate is a polymethylmethacrylate substrate.

18. The laminate according to claim 17, wherein the polymethylmethacrylate substrate has a thickness of 0.1 to 10 mm.

19. The laminate according to claim 1, wherein the transparent substrate is a glass substrate.

20. The laminate according to claim 19, wherein the glass substrate has a thickness of 0.1 to 5 mm.
